(19) United States
(12) Patent Application Publication
(10) Pub. No.: US 2014/0113073 A1
(43) Pub. Date: Apr. 24, 2014

(54) METHOD AND APPARATUS FOR FORMING SUBLIMATION IMAGES ON CASES FOR PORTABLE ELECTRONIC DEVICES

(71) Applicant: PHOTO U.S.A. CORP, Sunnyvale, CA (US)

(72) Inventors: James Peng, Sunnyvale, CA (US); Pengyu Wang, Beijing (CN)

(73) Assignee: PHOTO U.S.A. CORP, Sunnyvale, CA (US)

(21) Appl. No.: 13/829,810

(22) Filed: Mar. 14, 2013

(30) Foreign Application Priority Data
Oct. 18, 2012 (CN) 201210397091
Oct. 18, 2012 (CN) 201220534294

(51) Int. Cl. B41M 5/035

(52) U.S. Cl. CPC B41M 5/035
USPC 427/248.1; 428/32.6

(57) ABSTRACT

A method and apparatus for placing sublimation images on cases of electronic devices prints a plurality of separate sublimation images on a sheet of transfer paper at predetermined locations. The periphery of the images is cut but leaves each image attached to the sheet at least at three locations. A corresponding plurality of cases is placed on fixtures in a tray at locations corresponding to the images. The sheet is placed over the tray, aligning each image with a case, after which heat and pressure cause the images to transfer to the cases by sublimation transfer.

### BACKGROUND

Dye sublimation is a type of print method which transfers the printed image to the surface of substance by heating. With the development of the modern computer technology, it's easy to print the color image on paper using dyes appropriate for sublimation transfer so one can transfer individual image to a substrate. For example, one can print a family photo and transfer that image by dye sublimated onto mugs, plates or cell phone covers, to make these substrates looks like they are made especially for an individual. But dye sublimation transfer is usually either a batch process where numerous identical images are transferred onto the same substrate, or it is an individual process where a single image is transferred onto a single substrate for personal use.

A number of services offer customers the ability to place a personal image taken by the customer onto the customer's cell phone or other product. But to do that currently, the customer needs to send the image to a manufacturer that places a cover configured for the cell phone onto a supporting mold, and then places the printed image onto the cover with extensive effort taken to make the position of the image on the cover correct. This usually requires fastening the image to the supporting mold with tape which can withstand the high sublimation transfer temperature. The prepared support, case and image are then placed into a sublimation transfer machine, such as a vacuum sublimation machine for heating and image transfer. This type of operation has many procedures, is time consuming, is expensive and productiveness is low. Further, when placing the printed image onto the cover, positioning and temporarily fastening the image to the cover, the worker's hand will contact the mold or support and that requires that the mold or support be cool enough to hold by hand to prevent burns and scalding. Since sublimation dye transfer occurs at high temperatures, a lot of time is wasted in allowing the mold to cool down to remove the cover and place a new cover and image onto the mold. There is thus a need for a faster and more efficient method and apparatus to print individual, personalized images on selected covers for electronic devices, while reducing or avoiding the problems with handling hot molds and supports.

Further, the cover for the electronic device is thin and made of various plastics. The cover with the recently imprinted sublimation image is hot when it is removed from the sublimation transfer press and is thin enough and hot enough that it will distort and deform so that it will not snugly fit onto the cell phone it was originally designed to fit. Allowing the cover to cool while on the support or mold slows down production and increases cost. There is thus a need for an improved method and apparatus to place personalized sublimation images on covers for electronic devices that is faster, more efficient, lower cost and that does not warp the thin cover.

### BRIEF SUMMARY

A method and apparatus are used for sublimation transfer of images to products, preferably onto the surfaces of housings for electronic devices such as cell phones or tablet computers. A plurality of separate sublimation images are printed on a sheet of transfer paper at predetermined locations using colorants suitable for sublimation transfer. The periphery of the images is cut but leaves each image attached to the sheet at least at three locations. A corresponding plurality of cases is placed on fixtures in a tray at locations corresponding to the images. The sheet is placed over the tray, aligning each image with a case, after which heat and pressure cause the images to transfer to the cases by sublimation transfer.

There is thus advantageously provided a method of transferring sublimation images to a case of an electronic device. The method includes placing each of a plurality of cases on a support fixture configured to fit inside each case. The support fixtures are connected to a plate. A plurality of separate images is placed on a first surface of a transfer sheet with each image at a location and orientation corresponding to a different one of the cases on the plate. A first set of first cut lines are formed to extend around a periphery of each of the plurality of separate images while leaving each separate image attached to the transfer sheet at least at three locations. The cut lines form at least one corner. A second set of second cut lines is formed on opposing sides of each corner and extend inward from a location at or adjacent one of the first set of cut lines toward an opposing side of the image. The transfer sheet with images and cut lines is then placed on the support fixture and the transfer sheet is aligned so each of the plurality of images corresponds in location and orientation with a different one of the plurality of cases. Heat and pressure are then applied to achieve sublimation transfer of the images to the cases. The transfer sheet is removed after sublimation transfer is completed.

In further variations the step of applying heat and pressure includes placing a flexible sheet over the transfer sheet and applying negative pressure while heating with radiant energy. Thus, vacuum sublimation transfer can be used. The step of forming the first and second sets of cut lines may occur after the step of placing the plurality of images on the transfer sheet, but may occur before the images are placed on the sheet. The step of forming the first set of cut lines may form four cut lines in a rectangular configuration. The step of forming the second set of cut lines may form a plurality of the second cut lines at an angle of about 9-15 degrees from the perpendicular to the first cut line from which the second cut line extends. The electronic case preferably has a sidewall depending a distance L from a substantially flat portion of the case, and if so then the second cut line preferably has a length of about L. The transfer sheet is preferably not of a stretchable material and stretches less than about 1%.

There is also advantageously provided sublimation transfer comprising a flat sheet of transfer material having alignment features thereon. The sheet also has a plurality of separate images printed in sublimation dye transfer colorants on a first surface of the sheet with each image located at a separate location and separated by at least about two inches from an adjacent image. The sheet has a first set of first cut lines extending around a periphery of each of the plurality of images with each set of first cut lines leaving each image attached to the transfer sheet at least at three locations. The first cut lines form at least one corner. The sheet has a second set of second cut lines on opposing sides of each corner and extending inward from a location at or adjacent to one of the first set of cut lines toward an opposing side of the image.

In further variations, the first plurality of cut lines comprises four cut lines arranged in a rectangular configuration and may leave the image attached to the transfer sheet at each of four corners. The first cut lines preferably form four separate, non-joining sides of a rectangle and extend completely through the sheet of material. The second set of cut lines may include at least one second cut line at an angle of about 9-15 degrees from the perpendicular to the first cut line from which the second cut line extends. The transfer sheet is preferably of paper and stretches less than about 1% during sublimation transfer.

### BRIEF DESCRIPTION OF THE DRAWINGS

These and other advantages will be more apparent in view of the following discussion and drawings in which like numbers refer to like parts throughout, and in which:

FIG. 1 is a plan view of a transfer sheet having images thereon with first cut lines around a periphery of the image and second cut lines on opposing sides of each corner, with the dashed lines showing the flat portion of the final image;

FIG. 2 is a plan view of a cutting board having cutting blades to form the cut lines of FIG. 1;

FIG. 3 is a partial sectional view taken along 3-3 of FIG. 2;

FIG. 4 is a plan view of a mold tray having fixtures thereon for receiving cases of electronic devices;

FIG. 5 is an exploded sectional view taken along 5-5 of FIG. 4;

### DETAILED DESCRIPTION

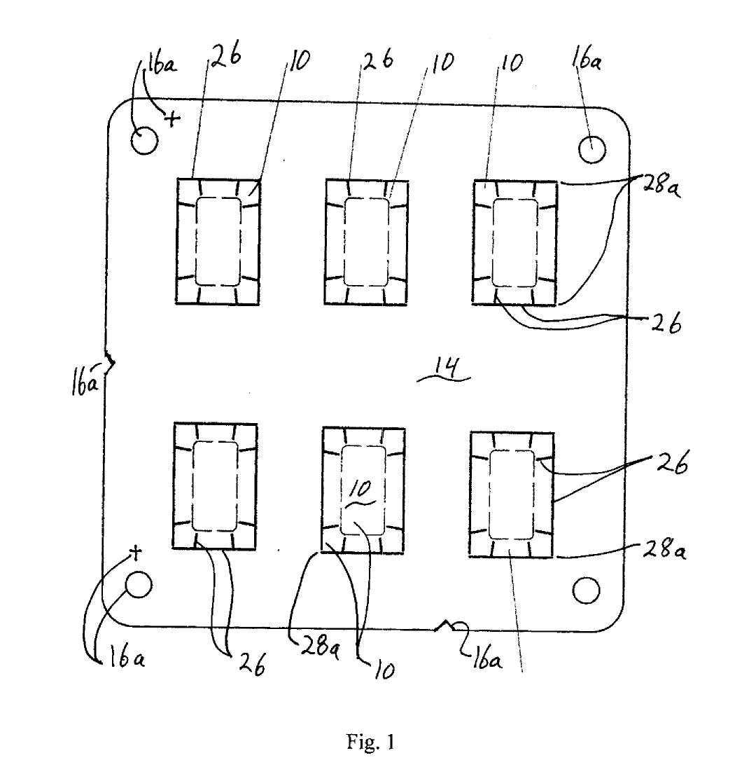

Referring to FIGS. 1-5, but primarily FIG. 1, a method and apparatus are disclosed for transferring a sublimation image 10 onto a case or cover 12 for a personal electronic device such as a cell phone, table computer, laptop computer, iPad, iPod or other handheld, portable electronic device. The covers 12 typically have a flat bottom surface 13 and four sidewalls 11 and the image 10 may extend over any and preferably all of these surfaces and sidewalls. Such covers 12 are typically made of various polymers or plastics, are rectangular in shape (rectangle includes a square), and have rounded, three dimensional corners. Because sublimation transfer requires the dyes forming the image penetrate into a coating layer under sufficient heat and pressure to transfer the dyes or inks, the cover 12 must be made of a material receptive to such ink/dye penetration and retention, or the cover must be coated with a layer of material suitable for receiving such ink or dye images. As used herein, reference to dye includes the various sublimation colorants, whether they are characterized as inks, dyes, or colorants. The covers 12 are typically relatively thin, usually less than about 3 mm but the thickness will vary.

The image 10 is initially formed on a transfer sheet 14 having alignment features 16 at two or more locations on the sheet. The transfer sheet 14 is configured to receive sublimation dye images and usually has a release layer that prevents the sheet 14 from adhering or sticking to the case 12 after sublimation is completed. The transfer sheet 14 is typically of paper with surface coatings suitable for use in sublimation transfer. The transfer sheet 14 is preferably made of inexpensive paper that lacks elastomeric or polymeric materials to allow stretching of the paper. The transfer sheet 14 preferably stretches so little that no optical distortion is visible in images sublimation coated on corners using the method and apparatus described herein, and that stretching is believed to be less than about 1%. The images 10 are preferably printed on the transfer paper in reverse as the image is to abut the case 12 directly during transfer. A background color may be printed over the desired image, as for example if the image is to appear against a white background. As desired, the image may be printed in its non-reverse orientation if it is printed on the side of the transfer sheet 14 opposite the case 12 during sublimation with the image passing through the transfer sheet, usually to be visible against an opaque (usually white) background left by the abutting surface of the transfer sheet on the case 12.

Alignment features 16 help orientate the sheet 14 relative to other equipment and variations on each piece of equipment will be given letter variations. The alignment features 16a on the transfer sheet 14 may comprise precisely located and shaped holes in the body of the sheet 14, or notches on one or more edges of the sheet may be used. The alignment features 16a may include printed indicia—especially if optical alignment is used. The alignment features 16a may include two edges on the sheet 14, preferably two orthogonal edges if the relative inclination is the edges is predetermined and sufficiently controlled. Two or more cylindrical holes of predetermined diameter and tolerance are preferred for the alignment features 16a and shown in FIG. 1. The number and location of the alignment features 16 will vary with the size of the transfer sheet 14 and possibly vary with the accuracy with which the images 10 must be positioned.

Preferably a plurality of images 10 are printed on a single transfer sheet 14, and one or more of the 10 images may be different, or various ones of the images may be the same, or all of the images may be the same. The images 10 are printed on the transfer sheet at predetermined locations selected and orientated relative to the alignment features 16. FIG. 1 shows six images 10 on transfer sheet 14, but the number will vary depending on the size of the sheet 14 and the sublimation transfer apparatus, among other factors. The images 10 are preferably separated from each other a distance that will vary with the specific sublimation device used for image transfer. A separation of a few inches, about 2-6 inches is believed suitable for cases 12 having a depth of about one inch.

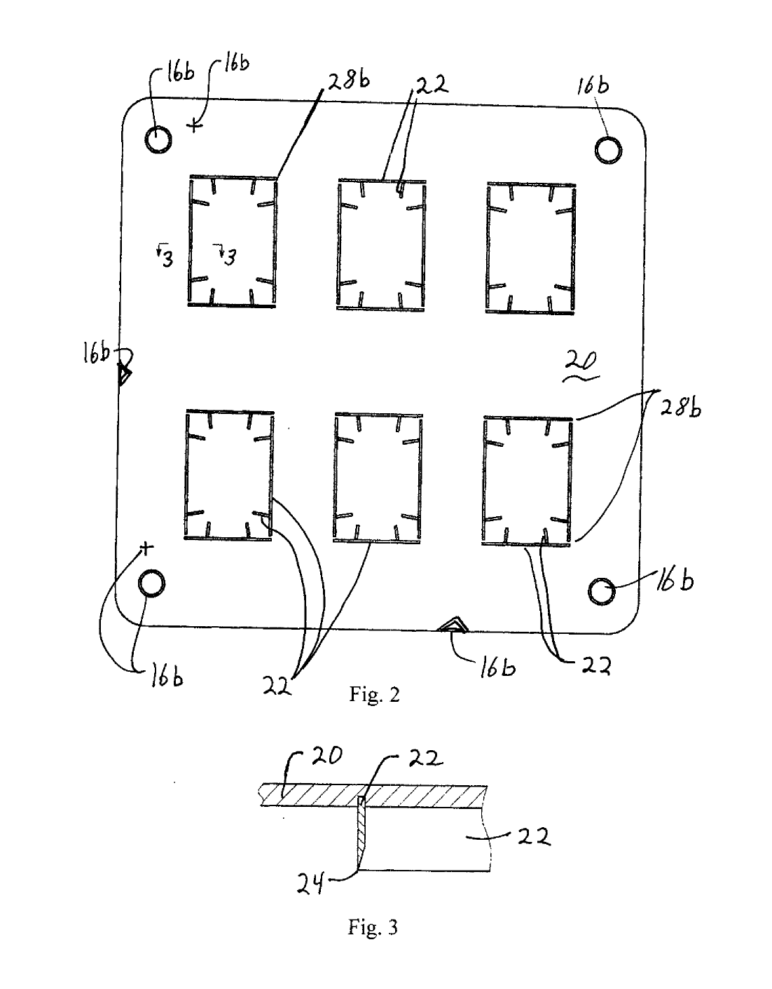

Referring to FIGS. 1-3, the transfer sheet 14 and alignment features 16 are configured to place each of the images 10 in alignment with various portions of a tool board 20. The tool board 20 (FIG. 2) could be wood or plastic or metal or other materials that allow the implementation of the functions performed by the tool board 20. The board 20 supports a plurality of cutting tools 22 (FIGS. 2-3) each having one or more cutting edges 24 (FIG. 3). The cutting tools 22 typically comprise strips of metal having one edge connected to the tool board 20 and the opposing edge shaped to form a knife edge or cutting edge 24. The cutting edges 24 are located to perform one or more of various cutting operations on the transfer sheet 14 and form various cut lines 26 (FIG. 1) in the transfer sheet 14. The cut lines 26 are discussed in more detail, but in the depicted embodiment for the rectangular case 12, the cut lines 26 form a rectangular shape configured so that the portion of the transfer sheet 14 bounded by the cut lines 26 form a rectangle dimensioned to fold around the case 12 and portions of the case that are to be imaged. Thus, the depicted cut liens 26 are generally rectangular but with additional cut lines at locations where the case 12 has three-dimensional curves, namely, at each of four corners. The cutting edges 24 and cutting tools 22 are preferably arranged on and fastened to the tool board 20 in the same arrangement as the cut lines 26.

The cutting operations include cutting completely through the thickness of the transfer sheet 14 at predetermined locations in a continuous cut of predetermined length to form cut line 26 in which opposing sides of the cut line are completely separated and thus provide a separated, weakened line along the length of the cut line 26 so the transfer sheet is more easily bent or folded or separated along that cut line 26. The cutting operation also includes scoring the sheet 14 which means the cutting edge 24 cuts part way through the thickness of the sheet 14 to form a cut line 26 that is weakened so that the transfer sheet 14 is more easily bent or folded along the length of the cut line 26 and more easily parted or torn along the length of the cut line 26. The cutting operations also include forming perforations that have a plurality of alternating short cuts through the thickness of the sheet 14 interposed with un-cut portions and/or scored portions to define cut line 26 that is weakened so that the transfer sheet 14 is more easily bent or folded along the length of the cut line 26 and more easily parted or torn along the length of the cut line 26. Whether the cut line 26 is completely cut through the sheet 14, perforated or scored, the cut line 26 still facilitates folding, bending or deformation of the transfer sheet along the length of the cut line 26, and preferably results in separating the sheet 14 along the cut line during manufacturing use.

There are preferably two sets of cut lines 26. The first set of cut lines 26 defines the periphery of the image 10 and forms the edge of the image abutting the edge of the sidewall 11 of the case when the image is transferred. The first set of cut lines 26 are shown as four straight cuts completely through the sheet 14, but the cut lines 26 do not intersect at their ends. Advantageously the cut lines leave the image 10 attached to the sheet 14 at least at three locations, and if the image is rectangular preferably leave it attached at least at four locations, one adjacent each corner. The second set of cut lines 26 are on opposing sides of each corner, and define the fold lines that allow the transfer sheet to fold around the corner. These are the cut lines that are angled at about 9-15 degrees from the perpendicular to the first cut line from which the second cut line extends. These second set of cut lines 26 extend inward from the first cut line toward the opposing side of the image defined by the first set of cut lines 26.

The tool board 20 is preferably flat and not easy to bend or deform, and made of a material that maintains the cutting tools 22 in the desired orientation and position during use, and does so with an accuracy sufficient for the intended use as described herein. The specific shape of the tool board 20 could be rectangle, or other shape, such as round, oval or trapezoid, or multisided configurations. The shape of the tool board will depend mostly upon the configuration of the transfer sheet 14 or the configuration of the heat transfer device used to achieve sublimation coating since it is desirable to form all of the cuts at one time. Thus, for applications using a clamshell type heat transfer mechanism or one that has platens separating along a generally straight axis, a rectangular tool board 20 is believed suitable for use with a rectangular transfer sheet 14.

In use, the cutting tools 22 are positioned on the tool board 20 to position the cutting edges 24 at locations selected to form the cut lines 26 on the transfer sheet 14. The cutting tools 22 and their cutting edges 24 are also located relative to alignment features 16 on the tool board. Thus, when the transfer sheet 14 is aligned with the board 20, the cutting edges 24 are located at the desired locations relative to the images 10. The tool board 20 thus has alignment features 16b on the board 20 that are located and configured to cooperate with alignment features 16a on the transfer sheet, with the alignment features 16a, 16b cooperating to position the transfer sheet 14 so the cut lines 26 are formed at desired locations relative to each image 10 on the transfer sheet, or relative to the location at which each image 10 will be placed on the transfer sheet 14. Thus, the tool board 20 may have precisely located and shaped pins 16b located to mate with the holes 16a in the transfer sheet 14, or notches on one or more edges of the board to be aligned with the notches 16a on the transfer sheet. The alignment features 16b may include printed indicia—especially if optical alignment is used to align the features 16b with corresponding features 16a on the transfer sheet. The alignment features 16b may include two protruding positioning stops on the tool board 20 located to engage two (preferably orthogonal) edges of the transfer sheet to position the sheet relative to the board 20 and cutting edges 24. Two or more cylindrical pins 16b with rounded or chamfered ends of predetermined diameter and tolerance are preferred for the alignment features 16b, with the pins 16b sized to snugly fit in the preferred holes 16a in the transfer sheet. Various other alignment mechanisms can be used to position the transfer sheet 14 relative to the cutting board 10 so the cutting edges 24 form the desired cut lines 26 on each image 10 or at the location of each image 10 during use. These various alignment features comprise means for aligning the transfer sheet 14 with the cutting board 20, and comprise means for aligning the images 10 with the cutting edges 24.

It is believed preferable if the cutting edges 24 align with the edges of the image 10 that are to be fastened to the case 12. Since the depicted case is for a cell phone the image 10 has four, straight sides bounded by four cut lines 26 formed by four cutting edges 24. A space 28b (FIG. 2) is left between the ends of the cutting edges 24 and supports 26, to form an uncut portion 28a at the corners of the image 10 in the transfer sheet 14 in order to keep the image 10 attached to the transfer sheet and avoid cutting entirely through the sheet entirely around the periphery of the image 10. If the cut lines 26 do not extend all the way through the transfer sheet 14, the space 28a, 28b could be omitted. Cutting tools 22 that are straight, with straight cutting edges 24 are less expensive to make, but the cutting tools 22 and edges 24 could be curved, especially at the corners.

In use, the transfer sheet is positioned over the tool board and the cut lines formed in the transfer sheet 14. This may be achieved by aligning the alignment features 16a, 16b and then pressing the transfer sheet 14 against the cutting edges 24, as for example, by affixing the sheet 14 to a flat, stiff surface such as a board that in turn is pressed against the cutting edges 24 with a predetermined or variable force. Alternatively, the tool board 20 may be positioned over the transfer sheet and the board pressed against the transfer sheet. In any event, after alignment features 16a, 16b are aligned, relative motion between the tool board 20 and alignment sheet 14 form cut lines 26 in a first surface of the transfer sheet 14. The tool board 20 is preferably, but optionally a generally flat part to hold cutting tools 22 as the cutting edges 26 are brought into contact with a transfer sheet 14. It is preferred that the sheet 14 be placed flat, with images 10 facing upward while the cutting tools 22 move downward against the sheet to form cut lines 26. Placing the transfer sheet 14 on a surface selected to accept repeated contact with cutting edges without unduly dulling the cutting edges is preferred.

The alignment sheet 14 with cut lines 26 is then placed on mold tray 30. The mold tray 30 has alignment features 16c which conform to features 16a, 16b described previously, and which cooperate with alignment features 16a on the transfer sheet to position the sheet relative to the mold tray 30, or more specifically, relative to support fixtures 32 on the mold tray 30.

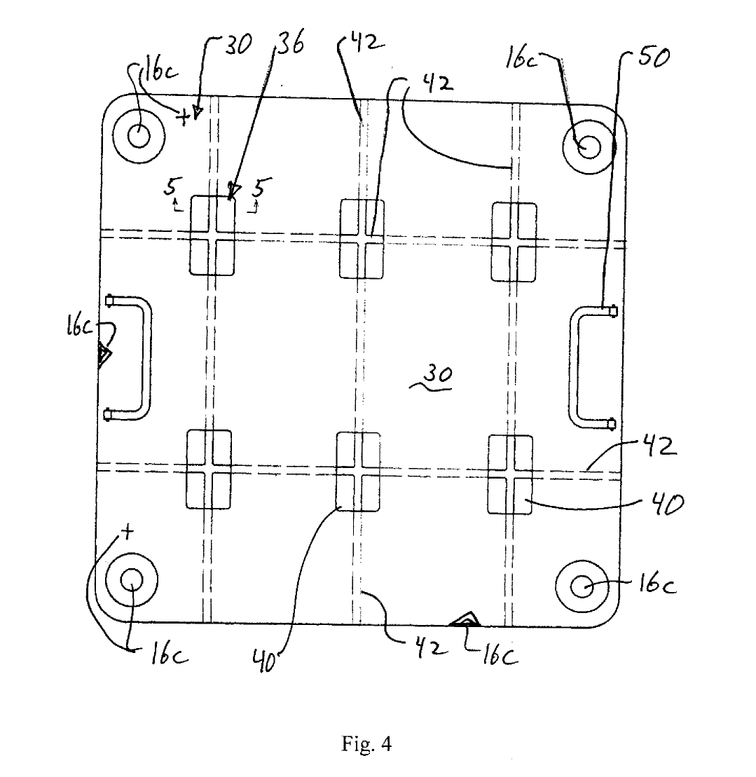

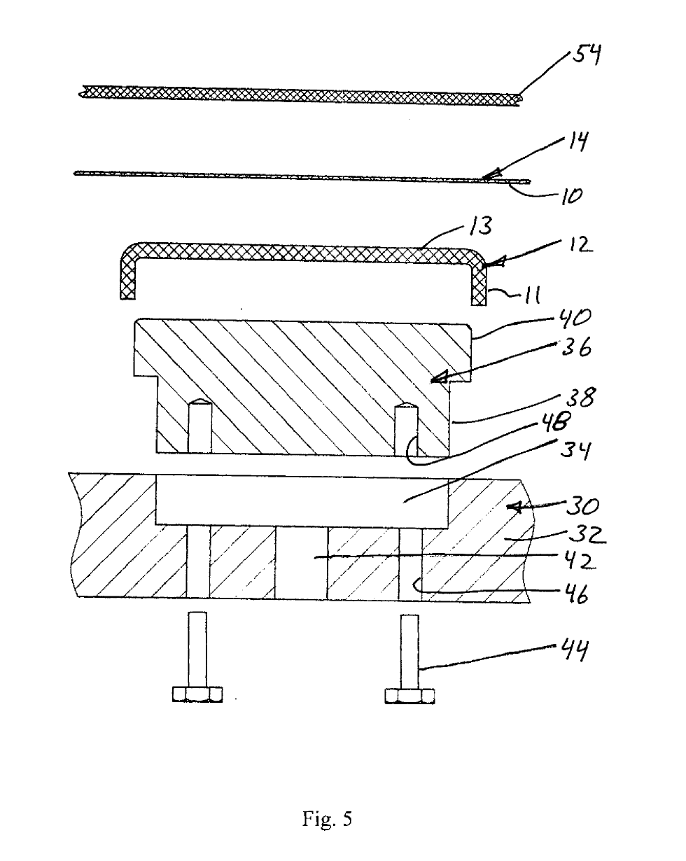

Referring to FIGS. 4 and 5, the mold tray 30 is shown with six support fixtures, although the number can vary from at least one to a plurality of fixtures, with the upper limit varying with the size of the case 10 and the size of the sublimation device. The mold tray 30 preferably has a stiff, strong bottom 32 usually made of metal that is able to withstand high sublimation temperatures of several degrees centigrade without deformation. The metal character preferably has fast heat diffusion capability in order to avoid hot spots and cold spots in the tray body 30, and it must not deform during use at the elevated temperatures required for sublimation transfer. The deformation resistance may require a thicker plate over a thinner one. Metals such as aluminum alloy, copperplate or steel plate are believed suitable for the mold tray 30.

At least one, and preferably a plurality of recesses 34 are formed in the bottom 34. A fixture 36 is advantageously placed in each recess 32. The fixture 36 has a base 38 configured to nest in the recess 34, so preferably the shapes of the mating parts of the fixture and base correspond with the base being slightly smaller than the recess. The fixture preferably has an upper support surface 40 larger than the base 38, with the base having a height greater than the depth of the recess 34 so that the upper support surface 40 has an outer periphery forming an overhang that is separated from and located above the upper surface of the bottom 32. The base 38 is thus shaped to mate with the recess 34 while the upper support surface 40 is configured to mate with the case 12 or other object being sublimation coated.

The upper support surface 40 is configured to nest inside of the case 10 and preferably provide a uniform support to the case 10 during sublimation transfer. The case 12 has a rectangular shape with sidewalls 11 and an exterior, flat surface 13 and rounded corners. The upper support surface 40 has a height that is preferably longer than the sidewalls 11 or about the same length as the sidewalls. If the upper support surface 40 is much shorter than the sidewalls 11 then the sidewalls may be unacceptably deformed inward during sublimation heating and transfer. As mentioned, the bottom 38 has a height so it extends above the recess 34 and upper surface of the bottom 32, and that allows the bottom edges of the sidewall 11 to be located above the top surface of the bottom 32. There is thus preferably a space or gap between the bottom edge of the sidewall 11 and the top surface of the bottom 32 of mold tray 32 during sublimation transfer.

The mold tray 30 preferably has a vent 42 in fluid communication with the recess 34. The vent 42 is shown as a series of channels extending from the bottom surface of the mold tray 30 to the bottom of the recess 34. The channels are shown in phantom in FIG. 4, and preferably extend along two perpendicular axes to join the six recesses 34 and place them in fluid communication with the edges of the mold tray 30 and the bottom of the mold tray 30. The channels 42 may be shallow channels with bores extending up to the recesses 34, or they may be deeper and intersect the recesses 34. Since deeper channels weaken the tray 30, the channels 42 are usually shallow and have offshoot channels or bores extending to the recesses 34.

As seen best in FIG. 5, each fixture 36 is optionally fastened to the bottom 32 of mold tray 30 using threaded fasteners 44 passing through bores 46 in the bottom 38 of fixtures 36 to threadingly engage threaded bores 48 in fixture 36. The fixtures 36 are preferably removably fastened to the mold tray 30, but may be simply nested in the recess 34 and held in position by the close fit between the bottom 38 and recess 34 and the weight of the fixture 36. Handles 50 are optionally fastened to opposing sides of the mold tray 30 for ease of handling the tray 30, as for example, moving the tray into and out of an oven or other heating device for sublimation transfer.

The fixtures 36 are located and orientated relative to alignment features 16c on the mold tray 30. By placing an imaged transfer sheet 14 on the mold tray 30, so that the alignment features 16a, 16c are aligned, the images 10 on the transfer sheet may be placed in registration with and in alignment with the cases 12 on fixtures 36. The alignment features 16c on the mold tray 30 are preferably located in about the same plane as the exterior surfaces of the cases 12 on the fixtures 36, so the cases 12 help support the transfer sheet 14 is a substantially uniform plane. The alignment features 16a, 16c may be offset, in which case the periphery of the transfer sheet will angle downward to allow the two alignment features to position the images 10 relative to the cases 12, or to position the sheet 14 relative to the mold tray 20, or to position any of those parts relative to the alignment features 16a, 16c. Once the sheet 14 is aligned to place the images 10 over the cases 12, the mold tray 30, cases 12 and images 10 are then ready for sublimation transfer.

The sublimation transfer may be achieved by various methods and devices, including placing the parts in various types of heated devices that physically press the transfer sheet and image 10 against the case 12, including pressing the image against the top and sidewalls 13, 11, respectively. Thus, applying pressure and heat for a sufficient time for the images 10 to sublimation transfer to the case 12 may be achieved by various ways.

Preferably though, vacuum or negative pressure used for sublimation transfer. A sheet of flexible material 54 such as rubber of silicon is placed over the mold tray 30, on top of the imaged transfer sheet 14. The sheet 14 is oriented so that the image 10 on the sheet will transfer to the case 12. In some applications the sheet 14 will have the images 100 abutting the case 10 and in other applications the image 100 may optionally pass through the transfer sheet. The assembly is then placed in a vacuum oven. The mold tray 30 may form the bottom platen of a sublimation oven, or it may be placed into a mating cavity of a sublimation oven or otherwise held in such an oven or heating device. Advantageously the bottom 32 has a plurality of through holes (not shown) in addition to the vent channels 42 such that applying a vacuum to the bottom of the mold tray 30 draws the flexible sheet 54 toward and against the mold tray, fixture 36 and case 12, pressing the images 10 against the case 12. The vent channels 42 by itself may also achieve or help achieve this deformation of the flexible liner 54 and application of pressure against the case 12. The assembly is then heated while the negative pressure is maintained. Radiant heat is preferred, but other forms of heating are usable. Suitable methods and devices for such vacuum sublimation transfer, and for sublimation transfer in general, are described in part in U.S. Pat. Nos. 6,814,831, 7,267,737 and 7,810,538, the complete contents of which are incorporated herein by reference.

As vacuum or negative pressure is applied the flexible sheet 54 conforms to the shape of the cover 12 on the fixture 36 and deforms the sheet 14 to conform to the shape of the case 12, pressing the image 10 against the case 12. Whether by vacuum or other mechanisms, the images 10 are subjected to pressure and temperature sufficient for sublimation transfer. Preferably the mold tray 30 is placed in a chamber with radiant heat, with the vacuum being applied before or after the tray is placed in the chamber. The vacuum may be released before or after the mold tray 30 is removed. The radiant heaters are usually shut off before removal of the mold tray 30.

The heat and pressure cause the image to undergo sublimation transfer to the case 12. Image transfer to the flat portions of the case 12 usually present little difficulty but the corners may result in the transfer sheet 14 or image 10 not smoothly deforming or folding against the case 12, causing imperfections in the image, or surface irregularities such as wrinkles. The cut lines 26 are located to facilitate the folding or bending or deformation of the transfer sheet 14 and image 12 to conform to the shape of the case. Advantageously, because the sidewalls 11 are offset from the top surface of the bottom 32, the flexible sheet 54 may deform along the bottom edges of the sidewalls 12 to press the image and transfer sheet against the case 12.

The location and type of the cut lines 26 will vary with the shape and contour of the case 12 and the stiffness of the transfer sheet 14. For rounded corners on the case 12, the cut lines as depicted in FIG. 1 are believed suitable. The cut lines extend to the portion of the image 10 that is flat in the final product, so the length of the cut line is about the length of the sidewall 11 and the curved corner. Since the depicted case 12 is rectangular it has longer and shorter opposing sidewalls 12. Advantageously, the cut lines 26 at the ends of the sidewalls are slightly inclined toward the immediately adjacent corner, and begin a distance from the corner that is about the radius of curvature of the corner when viewed perpendicular to the flat surface of the case to which the image is being applied. An angle of about 3-15 degrees, and preferably about 9-12 degrees from the perpendicular to the edge of the long side, is believed suitable for the depicted radius curvature of about 0.3-0.5 inches for an iPhone or other cellphone. The corresponding radius of curvature is about 0.5 to 1 inch for an iPad or other tablet computer. Thus, each pair of cut lines 26 on one of the four sides of the image 10 form a trapezoid with the longest leg extending along the free edge of the cut line 26, with a five sided piece at each corner.

During sublimation, the cut lines define locations at which the transfer sheet 14 and its image 10 fold as the image and transfer sheet wrap around the side walls 11 and corners of the case 12. The fold lines are preferably located to reduce image degradation or to achieve acceptable overlap of images along the corner cut lines 26. The cut lines 26 parallel to the length of the sides of the case 12 are preferably completely through the transfer sheet 14, while the cut lines 26 at the corners may be scored or perforated such that the transfer sheet integrity is maintained during handling but tears and folds along the cut lines when the flexible sheet 54 wraps around the case 12 during evacuation for sublimation transfer. Advantageously, the evacuation draws the flexible sheet 54 around the edges of the sidewalls 11 and severs or tears any uncut portion separating the cut lines 26 at the corners or other locations where there are three-dimensional corners or curves.

Depending on the relative sizes of the image 10 and the case 12 and its sidewalls 11, the image 10 may end on the sidewall 11, preferably at or shortly before the distal edge of the sidewall 11. Alternatively, the image may wrap around the distal edge of the sidewall 11. As appropriate, any remaining portions of the image that protrude beyond the edge of the sidewall may be removed, usually but cutting or abrasion. The images are separated on the transfer sheet 14 because the fixtures 36 must be spaced apart a distance sufficient to allow the flexible sheet of material 54 to deform along and apply pressure to the sidewalls 11 of the case 12. If the sidewalls 11 are short then less space between fixtures 36 is required. A spacing of a few inches is believed suitable with spacing of 2-6 believed suitable for most cases 12 for electronic devices having sidewalls 11 about one inch or so long.

Because the case 12 is typically made of plastic, the fixture 36 is used to maintain the shape of the case during sublimation and thus resists unacceptable deformation of the case during sublimation transfer and handling immediately after sublimation transfer. But product efficiencies require prompt removal of the imaged cases from the mold tray 30 and if the cases 12 are too hot when removed from the fixtures the cases will warp. Thus, after removal from the oven or heating unit, the flexible sheet 54 is removed along with the transfer sheet 14. Since the images 100 are affixed to the cases 12, the sheet 14 may have holes in it corresponding to the location of the images 100. The imaged cases are removed from the fixtures 36, preferably after cooling to such temperature that they do not permanently deform upon removal. Alternatively, the cases may be removed hot (e.g., by gloved hand) and placed on a cooling fixture having a configuration like that of fixture 36, which may be bolted to a frame or which may be free in order to make it easier to fit the hot, imaged case 12 onto the cooling fixture. The imaged case is removed from the cooling fixture when it has cooled enough that it will no longer deform under the weight of gravity or from thermal differential.

Thus, images 10 are placed at predetermined location(s) on transfer sheet 14 relative to alignment features 16a. The sheet 14 is provided with cut lines 26 at predetermined locations, preferably after images 14 are added. The alignment features 16a, 16b are used to provide the images at the desired predetermined location (which includes having the images 10 in the appropriate orientation). The imaged and cut transfer sheet 14 is then placed over mold tray 30 onto which cases 12 have been previously placed onto fixtures 36 in the mold tray 30. The alignment features 16a, 16c allow the placement so the images 10 align with the cases 12 and fixtures 36 (again including the correct orientation of images and cases). The flexible sheet 54 is then placed over the mold tray, cases and fixtures with the assembly being evacuated to apply pressure sufficient for sublimation transfer. The mold tray and assembly may be placed into a sublimation transfer machine or a heater or oven where the transfer sheet 14 and images 10 are heated to a sufficient temperature for a sufficient time to achieve sublimation transfer of each images 10 to one of the cases 12 aligned with one of the images. The pressure and heating temperature are stopped after sublimation is completed. The flexible sheet 54 and transfer sheet 14 are then removed from the heater. The imaged cases 12 are removed from the mold tray 30 either after cooling, or while deformably hot in which case they are placed on a cooling fixture for further cooling. The alignment features 16 allow the images 10 to be accurately placed on the cases 12.

It is important for the transfer sheet 14 to have the images 10 accurately located on the sheet relative to the position features 16a, and that the cut lines 26 be accurately located on the transfer sheet 14, and that the sheet 14 and images thereon be accurately positioned relative to the cases 12 on the mold tray 30. The alignment features 16a, 16b, 16c allow this, provided the cutting tools 22 and fixtures 36 are accurately positioned on the tool board 10 and mold tray relative to the alignment features 16b, 16c. Preferably the mold tray 30 has cylindrical posts with rounded ends for its alignment features 16c, and the tool board 20 has cylindrical posts with rounded ends for its alignment features 16b, with the transfer sheet 14 having circular holes for its alignment features 16a. But the shapes and nature of the alignment features can vary as discussed herein. Thus, for example, if the alignment features 16b, 16c are square or some other shape, the alignment features 16a would be square or some other corresponding shape.

The transfer sheet 14 may be any normal printing paper. The sheet 14 doesn't need to be any expensive or special extension or flexible paper especially designed for dye sublimation processes. Special sublimation transfer sheets which are stretchable are available, such as polyvinylchloride (PVC) sheets for printing. This type of stretchable material is very expensive and increases the cost for dye sublimation on multiple surfaces of three dimensional objects like the top 13 and junctures of the sidewalls 11 of the case 12. Further, this type of flexible material may former smoother corners on three dimensional objects, but in doing so the material stretches during the dye sublimation process and that stretching cause the resulting image to deform. The use of normal paper based transfer sheets, which are not stretchable and which lack sufficient polymers throughout the sheet 14 to make the sheet stretchable, are much cheaper and because of the cut lines 26, provide the ability to form sublimation images on three dimensional objects—without image distortion over curved surfaces. Indeed, because the support sheet 14 is not stretchable, it does not stretch around corners an amount sufficient to optically distort the sublimated images. There is thus provided a less expensive process with improved results for providing a sublimated image to a curved surface or to plural sides/surfaces of a multidimensional object.

Advantageously the mold tray 30 that is shaped the same as the cutting board 20 to make registration via the alignment features 16 easier. Further, it is useful if the mold tray 30 is configured to be readily received by the heating unit. Rectangular shapes are believed suitable for the mold tray 30 and cutting board 20. It is desirable that the tool board 20 have the cutting tools 22 located at each location where an image 10 will be placed on the transfer sheet 14, since that allows consistent cuts as contrasted to using one set of cutting tools to make plural cuts in the sheet 14. Thus, if there are six images 10 on the transfer sheet 14, there are preferably six sets of cutting tools to form the appropriate sets of cutting lines 26 at each of six locations in the transfer sheet 14. Likewise, the number and location of fixtures 36 corresponds to the number of images on the transfer sheet 14. The process thus preferably includes a molt tray 30 with the same number of fixtures 36 at the same locations as the images 10 on the transfer sheet 14, and includes a tool board 20 with the same number of cutting tools 22 to form the same cut lines 26 at the same locations on the images 10 on the transfer sheet 14.

The cutting tools 22 on the tool board 20 ensure that the cut lines 26 are placed at the same location on each transfer sheet 14 for which the alignment features 16a, 16b are aligned. The alignment features 16a preferably cooperate with an imaging device to ensure that the images 10 are positioned accurately relative to the alignment features 16a. Thus, a transfer sheet 14 preferably has its alignment features 16a used to orientate the sheet relative to the images formed by the imaging device relative to the sheet or to the features 16a. Alternatively, the images 10 are applied by a conventional printer using sublimation dyes printed on conventional paper passed through the printer. The printing accuracy is repeatable enough that images 10 printed on the transfer sheet are positioned relative to alignment features 16a for use in the method and apparatus disclosed herein. The ability to print the same or different images 10 on one transfer sheet 14 allows great flexibility and economy of scale. The ability to position multiple images on the tool board and place the cut lines 26 accurately on each image allows reduction in process time. The ability to quickly and accurately position the transfer sheet 14 on the mold tray 30 holding a plurality of cases, and the alignment of those cases and images, also provides great flexibility and economy of scale. The system and process thus allows individualized images 10 to be placed on personalized cases 12, faster and more economically than before. The use of standard transfer paper 14 rather than more expensive stretchable paper further reduces costs. The ability to repeatedly and accurately form cut lines 26 to allow the use and folding of the standard paper transfer sheet 14 around three dimensional corners while achieving an un-stretched image is very desirable and aesthetically pleasing. The ability to process a plurality of images and covers at one time is much more efficient and faster than forming each cover, one at a time.

The above description is given by way of example, and not limitation. Given the above disclosure, one skilled in the art could devise variations that are within the scope and spirit of the invention disclosed herein, including various ways of arranging the cutting tools 22 to form cut lines 26 to achieve visually acceptable images at three dimensional portions of a product. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of transferring sublimation images to a case of an electronic device, comprising:
placing each of a plurality of said cases on a support fixture configured to fit inside each case, the support fixtures connected to a plate;
placing a plurality of separate images on a first surface of a transfer sheet with each image at a location and orientation corresponding to a different one of the cases on the plate;
forming a first set of first cut lines extending around a periphery of each of said plurality of separate images while leaving each separate image attached to the transfer sheet at least at three locations, the cut lines forming at least one corner;
forming a second set of second cut lines on opposing sides of each corner and extending inward from a location at or adjacent one of the first set of cut lines toward an opposing side of the image;
placing the transfer sheet with images and cut lines on the support fixture and aligning the transfer sheet so each of the plurality of images corresponds in location and orientation with a different one of the plurality of cases; and
applying heat and pressure to achieve sublimation transfer of the images to the cases; and
removing the transfer sheet after sublimation transfer is completed.

2. The method of claim 1, wherein the step of applying heat and pressure includes placing a flexible sheet over the transfer sheet and applying negative pressure while heating with radiant energy.

3. The method of claim 1, wherein the step of forming the first and second sets of cut lines occurs after the step of placing the plurality of images on the transfer sheet.

4. The method of claim 1, wherein the step of forming the first set of cut lines comprises forming a four cut lines in a rectangular configuration.

5. The method of claim 4, wherein the step of forming the second set of cut lines forms a plurality of the second cut lines at an angle of about 9-15 degrees from the perpendicular to the first cut line from which the second cut line extends.

6. The method of claim 4, wherein the case has a sidewall depending a distance L from a substantially flat portion of the case, and wherein the second cut line has a length of about L.

7. The method of claim 1, wherein the transfer sheet is not of a stretchable material and stretches less than about 1%.

8. The method of claim 1, comprising the further step of removing the cover from the fixture while the cover is hot and placing the hot cover on a cooling fixture that maintains the shape of the cover until the cover cools to a temperature where it does not permanently deform under the weight of gravity or deform by handling forces.

9. A sublimation transfer sheet, comprising:
a flat sheet of transfer material having alignment features thereon;
a plurality of separate images printed in sublimation dye transfer colorants on a first surface of the sheet, each image located at a separate location and separated by at least about two inches from an adjacent image;
a first set of first cut lines around a periphery of each of said plurality of images, each set of first cut lines leaving each image attached to the transfer sheet at least at three locations, the first cut lines forming at least one corner;
a second set of second cut lines on opposing sides of each corner and extending inward from a location at or adjacent to one of the first set of cut lines toward an opposing side of the image.

10. The transfer sheet of claim 9, wherein the first set of cut lines comprises forming four cut lines in a rectangular configuration with the four cut lines not intersecting.

11. The transfer sheet of claim 8, wherein the second set of cut lines includes at least one second cut line at an angle of about 9-15 degrees from the perpendicular to the first cut line from which the second cut line extends.

12. The transfer sheet of claim 9, wherein the first set of cut lines form a rectangle and leave the image attached to the transfer sheet at each of four corners.

13. The transfer sheet of claim 9, wherein the sheet is of paper and stretches less than about 1% during sublimation transfer.

14. The transfer sheet of claim 9, wherein the first cut lines form four separate, non-joining sides of a rectangle and extend completely through the sheet of material.
